(19) United States
(12) Patent Application Publication
(10) Pub. No.: US 2012/0008931 A1
(43) Pub. Date: Jan. 12, 2012

(54) APPARATUS AND METHOD FOR DISPLAYING WORLD CLOCK IN PORTABLE TERMINAL

(75) Inventors: Shin-Jun Lee, Yongin-si (KR); Kwang-Cheol Choi, Gwacheon-si (KR); Dae-kyu Shin, Suwon-si (KR); Seung-Pyo Ryu, Suwon-si (KR); Hyung-Jin Bae, Pyeongtaek-si (KR); Sung-Joo Ahn, Seoul (KR); Ik-Hwan Cho, Suwon-si (KR); Jin-He Jung, Suwon-si (KR); Tae-Hwan Son, Suwon-si (KR); Sang-Kyung Lee, Anyang-si (KR)

(73) Assignee: SAMSUNG ELECTRONICS CO., LTD., Suwon-si (KR)

(21) Appl. No.: 13/175,734

(22) Filed: Jul. 1, 2011

(30) Foreign Application Priority Data
Jul. 7, 2010 (KR) 10-2010-0065289

(51) Int. Cl. G09G 5/00; G03B 17/02

(52) U.S. Cl. 396/287; 345/633

(57) ABSTRACT

An apparatus and method display a world clock on the basis of an Augmented Reality (AR) scheme in a portable terminal. The method for displaying information in the portable terminal includes obtaining camera image data from a camera. The method also include searching for a city corresponding to a camera location and a camera viewpoint direction on the basis of a memory. The method further includes obtaining information on the found city and displaying the obtained information on the found city by compositing the information into the obtained camera image data.

### CROSS-REFERENCE TO RELATED APPLICATION(S) AND CLAIM OF PRIORITY

The present application is related to and claims the benefit under 35 U.S.C. §119(a) of a Korean patent application filed in the Korean Intellectual Property Office on Jul. 7, 2010 and assigned Serial No. 10-2010-0065289, the entire disclosure of which is hereby incorporated by reference.

### TECHNICAL FIELD OF THE INVENTION

The present invention relates to an apparatus and method for displaying a world clock in a portable terminal. More particularly, the present invention relates to an apparatus and method for displaying a world clock on the basis of an Augmented Reality (AR) scheme in a portable terminal.

### BACKGROUND OF THE INVENTION

An Augmented Reality (AR) scheme, which has recently become a popular issue, is one field of virtual reality technology. In the AR scheme, virtual objects are “composited” (i.e., added or superimposed) into an actual environment to reinforce additional information which is difficult to obtain in a real world. Due to its technical novelty as well as convenience of use and entertainment aspects, the AR scheme is being applied more frequently.

The use of portable terminals is rapidly increasing due to convenience of portability, and thus service providers (and/or terminal manufacturers) are competitively developing terminals that include more convenient functions to ensure more users. For example, the portable terminals provide various functions such as a phone book, a game, a scheduler, a short message, an Internet, an alarm, an MPEG Audio Layer-3 (MP3), a digital camera, an electronic dictionary, a world clock display, and the like.

The world clock display function is a function for displaying a world clock according to cities of each country. A portable terminal that includes a conventional world clock display function determines a local time of a city desired by a user and displays the time on a screen. The information displayed on the screen has a simple list format, and simply provides only time information of the city and does not provide other effective information related to the city. Therefore, there is a problem in that a demand of a user who sets a high value on a visual effect cannot be satisfied.

### SUMMARY OF THE INVENTION

To address the above-discussed deficiencies of the prior art, it is a primary aspect of the present invention to solve at least the above-mentioned problems and/or disadvantages and to provide at least the advantages described below. Accordingly, an aspect of the present invention is to provide an apparatus and method for displaying a world clock in a portable terminal.

Another aspect of the present invention is to provide an apparatus and method for displaying a world clock on the basis of an Augmented Reality (AR) scheme in a portable terminal.

Another aspect of the present invention is to provide an apparatus and method for displaying information (i.e., time and other extra information) for each city (or country) of the world by compositing the information into a camera image on the basis of an AR scheme in a portable terminal. Herein, the extra information includes a variety of information such as a weather, a direction, a distance to a specific city (or country), whether to apply a summer time system, a population, an area, tour information, a primary landmark, and the like.

In accordance with an aspect of the present invention, a method of displaying information in a portable terminal is provided. The method includes obtaining camera image data from a camera, searching for a city corresponding to a camera location and a camera viewpoint direction on the basis of a memory, obtaining information on the found city, and displaying the obtained information on the found city by compositing the information into the obtained camera image data.

In accordance with another aspect of the present invention, a portable terminal includes a camera configured to obtain camera image data. The terminal also includes a controller configured to search for a city corresponding to a camera location and a camera viewpoint direction on the basis of a memory. The controller is also configured to obtain information on the found city, and composite the obtained information on the found city into the obtained camera image data. The terminal further includes a display unit configured to display the city information being composited to the camera image data.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a structure of a portable terminal according to an embodiment of the present invention;

FIGS. 2A and 2B are flowcharts illustrating a method for displaying a world clock on the basis of an Augmented Reality (AR) scheme in a portable terminal according to an embodiment of the present invention; and

FIG. 3 illustrates an example of a method for displaying a world clock on the basis of an AR scheme in a portable terminal according to an embodiment of the present invention.

### DETAILED DESCRIPTION OF THE INVENTION

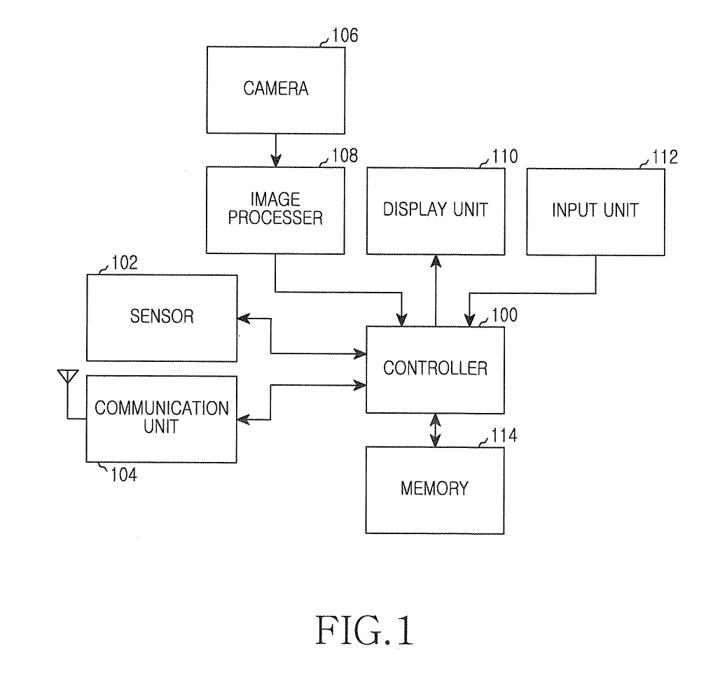

FIGS. 1 through 3 discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged terminal.

The present invention described hereinafter relates to a technique for displaying information (i.e., time and other extra information) for each city (or country) of the world by compositing the information into a camera image on the basis of an Augmented Reality (AR) scheme in a portable terminal. Herein, the extra information includes a variety of information such as a weather, a direction, a distance to a specific city (or country), whether to apply a summer time system, a population, an area, tour information, a primary landmark, and the like.

A portable terminal described hereinafter is a terminal that includes a camera, and may include any one or more of a cellular phone, a Personal Communication System (PCS), a Personal Data Assistant (PDA), International Mobile Telecommunication-2000 (IMT-2000) terminal, a Personal Computer (PC), a laptop computer, a digital camera, and the like. The following description will be based on general configurations of the above examples.

FIG. 1 is a block diagram illustrating a structure of a portable terminal according to an embodiment of the present invention.

Referring to FIG. 1, the portable terminal includes a controller 100, a sensor 102, a communication unit 104, a camera 106, an image processer 108, a display unit 110, an input unit 112, and a memory 114.

The controller 100 provides overall control to the portable terminal. For example, the controller 100 processes and controls voice communication and data communication. Further, in addition to these functions, according to the present invention, the controller 100 performs a function for displaying information (i.e., time and other extra information) for each city (or country) of the world by compositing the information into a camera image on the basis of an AR scheme. Herein, the extra information includes a variety of information such as a weather, a direction, a distance to a specific city (or country), whether to apply a summer time system, a population, an area, tour information, a primary landmark, and so forth.

In one aspect of operation, when a menu for displaying a world clock is selected by the input unit 112, the controller 100 obtains camera image data by the use of the camera 106 and the image processer 108, and obtains information on a camera location and a camera viewpoint direction by the use of the sensor 102. Thereafter, by using information regarding a location for each city (or country) of the world and stored in the memory 114 and the obtained information on the camera location and the camera viewpoint direction, the controller 100 searches for a city (or country) which exists in the current camera location and camera viewpoint direction, and requests a web-based server (not shown) to send information on the found city (or country) and thus receives the information by the use of the communication unit 104. That is, the controller 100 requests the web-based server (not shown) to send time and other extra information (e.g., a weather, a direction, a distance to a specific city (or country), whether to apply a summer time system, a population, an area, tour information, a primary landmark, and so forth) of the found city (or country) by the use of the communication unit 104. Thereafter, based on the information regarding the location for the found city (or country) and stored in the memory and the obtained information regarding the camera location and the camera viewpoint direction, the controller 100 determines a composition location of the information on the found city (or country) included in the obtained camera image data, composites the received city information (or country information) at the determined composition location included in the obtained camera image data, and then provides the resultant information to the display unit 110.

The sensor 102 can be implemented by combining one or two (or more) sensors among a Global Positioning System (GPS) receiver, a gyro sensor, a geomagnetic sensor, and a gravity sensor. The sensor 102 obtains information on the camera location and the camera viewpoint direction.

The communication unit 104 includes a Radio Frequency (RF) transmitter for up-converting or amplifying a frequency of a transmitted signal and an RF receiver for performing low-noise amplification on a received signal and for down-converting a frequency thereof.

The camera 106 includes a camera sensor for converting an optical signal detected in image capturing into an electrical signal and a signal processor for converting an analog image signal captured from the camera sensor into digital image data. Herein, the camera sensor can be implemented by using a Charge Coupled Device (CCD) sensor, and the signal processor can be implemented by using a Digital Signal Processor (DSP).

The image processer 108 generates screen data for displaying the camera image data provided from the camera 106. The image processer 108 includes a video codec (not shown). The video codec codes the image data according to a predetermined scheme, or decodes the coded image data into original image data.

The display unit 110 displays information such as state information, which is generated while the portable terminal operates, a limited number of characters, moving and still pictures, and the like. The display unit 110 may be a color Liquid Crystal Display (LCD) or any other suitable display.

The input unit 112 includes a plurality of function keys such as numeral key buttons, a menu button, a cancel (or delete) button, an OK button, a talk button, an end button, a camera button, an Internet access button, and the like. Key input data, which is input when the user presses these keys, is provided to the controller 100.

The memory 114 stores a microcode of a program for processing and control of the controller 100 and a variety of reference data. In particular, according to the present invention, the memory 114 stores a program for displaying information (i.e., time and other extra information) for each city (or country) of the world by compositing the information into a camera image on the basis of an AR scheme. Herein, the extra information may include a weather, a direction, a distance to a specific city (or country), whether to apply a summer time system, a population, an area, tour information, a primary landmark, and the like. In addition, the memory 114 stores static data for each city (or country) of the world, for example, information on a location for each city (or country) of the world.

The web-based server (not shown) stores dynamic data (e.g., a weather, a direction, a distance to a specific city (or country), whether to apply a summer time system, a population, an area, tour information, a primary landmark, and the like) for each city (or country) of the world, and when information on a specific city (or country) is requested from the communication unit 104 of the portable terminal. The web-based server also searches for dynamic data of the city (or country) and provides the found data.

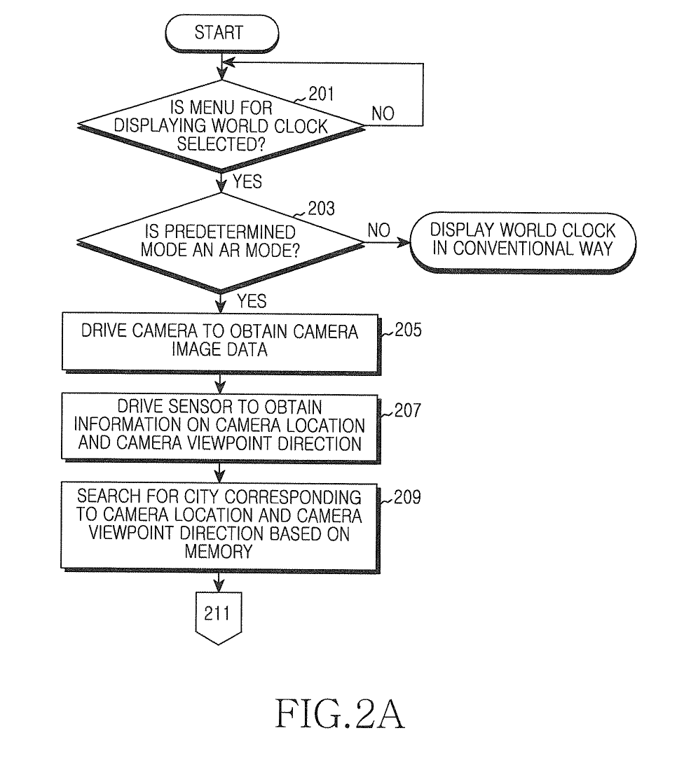

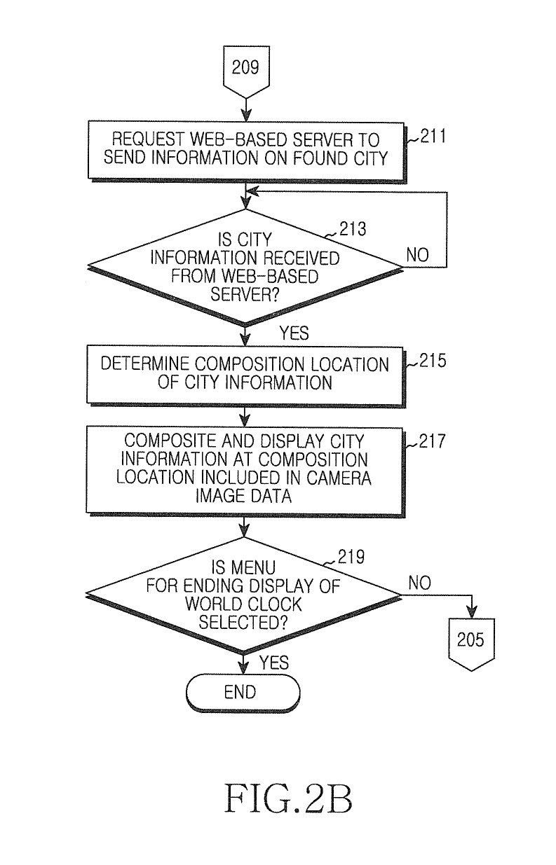

FIGS. 2A and 2B are flowcharts illustrating a method for displaying a world clock on the basis of an AR scheme in a portable terminal according to an embodiment of the present invention.

Referring to FIGS. 2A and 2B, the portable terminal determines whether a menu for displaying the world clock is selected according to user's key manipulation in step 201.

If it is determined in step 201 that the menu for displaying the world clock is selected, proceeding to step 203, the portable terminal determines whether a display mode predetermined in the menu for displaying the world clock is an AR mode of the present invention.

If it is determined in step 203 that the display mode predetermined in the menu for displaying the world clock is not the AR mode of the present invention, that is, if it is a list mode of the conventional technique, the portable terminal displays the world clock in a simple list format on a screen according to the conventional technique.

Otherwise, if it is determined in step 203 that the display mode predetermined in the menu for displaying the world clock is the AR mode of the present invention, proceeding to step 205, the portable terminal drives a camera to obtain camera image data. In step 207, the portable terminal drives a sensor to obtain information on a camera location and a camera viewpoint direction, and then proceeds step 209.

In step 209, the portable terminal searches for a city (or country) corresponding to the obtained camera location and camera viewpoint direction on the basis of a memory. Herein, information on a location for each city (or country) of the world is stored in the memory. Therefore, by using the information regarding the location for each city (or country) of the world and stored in the memory and the obtained information on the camera location and camera viewpoint direction, the portable terminal can search for a city (or country) which exists in the current camera location and camera viewpoint direction. Although it is described in the embodiment of the present invention that the city (or country) which exists in the current camera location and camera viewpoint direction is searched for from all cities (or countries) of the world, this is for exemplary purposes only. Thus, the city (or country) which exists in the current camera location and camera viewpoint direction can be searched for from some cities (or counties) selected by a user.

In step 211, the portable terminal requests a web-based server to send information on the found city (or country). For example, the portable terminal can request the web-based server to send time information of the found city (or country) and other extra information on the found city (or country) (e.g., a variety of information on a weather, a direction, a distance to a specific city (or country), whether to apply a summer time system, a population, an area, tour information, a primary landmark, and the like). Although it is described in the embodiment of the present invention that the time information of the found city (or country) is received by a request sent to the web-based server, this is for exemplary purposes only. Thus, without having to send the request to the web-based server, the portable terminal can determine the time information of the found city (or country) on the basis of time and time-difference information at a current location.

In step 213, the portable terminal determines whether the information on the found city (or country) is received from the web-based server.

If the information on the found city (or country) is received from the web-based server in step 213, proceeding to step 215, the portable terminal determines a composition location of the information on the found city (or country) included in the obtained camera image data, on the basis of the information regarding the location for the found city (or country) and stored in the memory and the obtained information regarding the camera location and the camera viewpoint direction. For example, if the found city (or country) is located to the left from a camera center with respect to the camera location and the camera viewpoint direction, the composition location of the information regarding the found city (or country) can be determined to the left from a screen center.

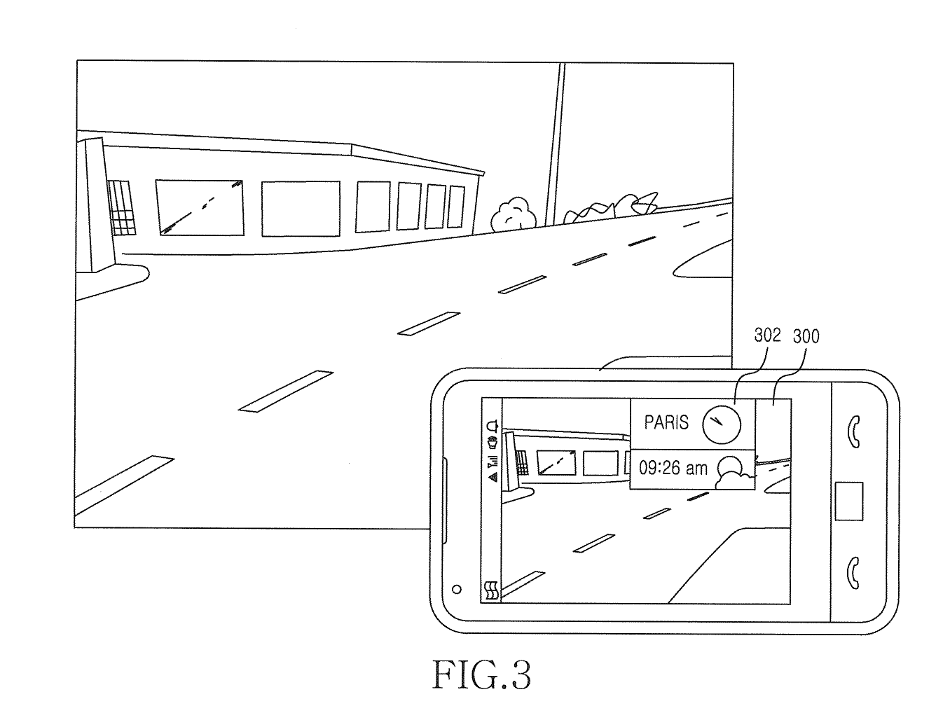

In step 217, the portable terminal displays the received city information (or country information) by compositing the information at the determined composition location included in the obtained camera image data. For example, as illustrated in FIG. 3, the portable terminal can display city information (or country information) 302 included in camera image data 300 obtained by using the camera.

In step 219, the portable terminal determines whether a menu for ending the display of the world clock is selected.

If it is determined in step 219 that the menu for ending the display of the world clock is not selected, returning to step 205, the subsequent steps are repeated.

Otherwise, if it is determined in step 219 that the menu for ending the display of the world clock is selected, the procedure of FIG. 2 ends.

As described above, the present invention provides a method for displaying information (i.e., time and other extra information) for each city (or country) of the world by compositing the information into a camera image on the basis of an Augmented Reality (AR) scheme in a portable terminal. Herein, the extra information includes a variety of information such as a weather, a direction, a distance to a specific city (or country), whether to apply a summer time system, a population, an area, tour information, a primary landmark, and the like. Accordingly, the present invention has an advantage in that effect information for each city (or country) of the world can be provided all together, and a demand of a user who sets a high value on a visual effect can be satisfied.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of displaying information in a portable terminal, the method comprising:
obtaining camera image data from a camera;
searching for a city corresponding to a camera location and a camera viewpoint direction on the basis of a memory;
obtaining information on the found city; and
displaying the obtained information on the found city by compositing the information into the obtained camera image data.

2. The method of claim 1, wherein the information on the found city comprises at least one of time, a weather, a direction, a distance to a specific city (or country), whether to apply a summer time system, a population, an area, tour information, and a primary landmark.

3. The method of claim 1, further comprising obtaining information on the camera location and the camera viewpoint direction by driving a sensor.

4. The method of claim 3, further comprising determining a composition location of the obtained city information included in the obtained camera image data on the basis of information regarding a location of the found city and stored in the memory and the information on the obtained camera location and camera viewpoint direction.

5. The method of claim 3, wherein searching for the city comprises searching for a city which exists in a current camera location and camera viewpoint direction by using information regarding a location for each city of the world and stored in the memory and the obtained information on the camera location and camera viewpoint direction.

6. The method of claim 3, wherein the sensor includes at least one of a Global Positioning System (GPS) receiver, a gyro sensor, a geomagnetic sensor, and a gravity sensor.

7. The method of claim 1, wherein obtaining the information on the found city comprises:
requesting a web-based server to send information on the found city; and
receiving the information on the found city from the web-based server.

8. A portable terminal comprising:
a camera configured to obtain camera image data;
a controller configured to search for a city corresponding to a camera location and a camera viewpoint direction on the basis of a memory, obtain information on the found city, and composite the obtained information on the found city into the obtained camera image data; and
a display unit configured to display the city information being composited to the camera image data.

9. The portable terminal of claim 8, wherein the information on the found city comprises at least one of time, a weather, a direction, a distance to a specific city (or country), whether to apply a summer time system, a population, an area, tour information, and a primary landmark.

10. The portable terminal of claim 8, further comprising a sensor configured to obtain information on the camera location and the camera viewpoint direction.

11. The portable terminal of claim 10, wherein the controller determines a composition location of the obtained city information included in the obtained camera image data on the basis of information regarding a location of the found city and stored in the memory and the information on the obtained camera location and camera viewpoint direction.

12. The portable terminal of claim 10, further comprising a memory for storing information on a location for each city of the world, wherein the controller searches for a city which exists in a current camera location and camera viewpoint direction by using the information on the location for each city of the world and the obtained information on the camera location and camera viewpoint direction.

13. The portable terminal of claim 10, wherein the sensor includes at least one of a Global Positioning System (GPS) receiver, a gyro sensor, a geomagnetic sensor, and a gravity sensor.

14. The portable terminal of claim 8, further comprising a communication unit configured to request a web-based server to send information on the found city and receive the information on the found city from the web-based server.

15. The portable terminal of claim 8, further comprising an input unit configured to receive key input data when a user manipulates one or more keys.

16. The portable terminal of claim 8, further comprising an image processor configured to generate screen data for displaying the camera image data.

17. The portable terminal of claim 15, where the input unit comprises a plurality of function keys.

18. The method of claim 1, further comprising:
receiving, at an input unit, key input data when a user manipulates one or more keys.

19. The method of claim 1, further comprising:
generating screen data for displaying the camera image data.

20. The method of claim 18, where the input unit comprises a plurality of function keys.
